(19) United States
(12) Patent Application Publication
(10) Pub. No.: US 2016/0084473 A1
(43) Pub. Date: Mar. 24, 2016

(54) METHOD FOR ILLUMINATING A DISPLAY USING A SECONDARY OPTICAL ELEMENT AND A LIGHT-DIFFUSING SUBSTRATE, DEVICE FOR ILLUMINATING A DISPLAY

(71) Applicants: Emil Rafic ogli ASLANOV, Letnii otdix (RU); Leonid Leonidovich DOSKOLOVICH, Samara (RU); Nikolay Livovich KAZANSKIY, Samara (RU); Mikhail Alexandrovich MOISEEV, Samara (RU); SAMARA STATE AEROSPACE UNIVERSITY (SSAU), Samara (RU)

(72) Inventors: Emil Rafic ogli ASLANOV, Moskovskaya obl. (RU); Leonid Leonidovich DOSKOLOVICH, Samara (RU); Nikolay Livovich KAZANSKIY, Samara (RU); Mikhail Alexandrovich MOISEEV, Samara (RU)

(21) Appl. No.: 14/889,427

(22) PCT Filed: Apr. 29, 2014
(86) PCT No.: PCT/RU2014/000313

§ 371 Date: Nov. 5, 2015

(30) Foreign Application Priority Data
May 7, 2013 (RU) 2013121543

(51) Int. Cl. F21V 7/00; F21V 7/04

(52) U.S. Cl. CPC F21V 7/0008; F21V 7/04; F21Y 2101/02

(57) ABSTRACT

The invention relates to methods and devices for controlling the intensity and direction of light emerging from an independent source, inter alia to design-based interactions of optical devices in particular for systems for illuminating coloured liquid crystal displays. The method comprises redirecting radiation from sources with the aid of lenses (reflectors). The radiation is redirected onto a light-diffusing substrate and uniformly illuminated sections are produced which in turn form a uniform illumination of the display. The technical result of the use of the present invention consists in improving the light characteristics of displays such as efficiency, lighting homogeneity, and reducing the cost of the system by virtue of the use of lenses (reflectors) with one working surface and a smaller number of highly effective light sources (light-emitting diodes).

This application is the national stage entry of International Appl. No. PCT/RU2014/000313, filed Apr, 29, 2014, which claims priority to Russian Patent Application No. 2013121543, filed May 7, 2013. All claims of priority to such applications are hereby made, and such applications are hereby incorporated in their entirety by reference.

### FIELD OF THE INVENTION

The present invention relates to methods and devices for controlling the intensity and direction of light emerging from an independent source, including to design-based interrelations of optical devices, in particular for systems for illuminating color liquid crystal displays.

### BACKGROUND OF THE INVENTION

One of the main tasks in the development of illuminating systems for displays with a background illumination is to provide a uniform illumination of the screen with a small thickness of the optical system.

It is known in the art the invention “An illumination device, a display and a television receiver” (RU patent No 2473836C1, Int. CI. F21V19/00, published on Jan. 27, 2013) of the Japanese company Sharp, in which, to solve the task of providing a uniform illumination, the display uses a device comprising a frame, a reflecting plate, a plurality of cold-cathode tubes, several layers of optical elements (such as light-diffusers) and lamp clamps.

The illumination system based on cold-cathode tubes enables to achieve a high degree of illumination uniformity but has a series of drawbacks such as the low energy efficiency of lamps, narrow color coverage, low contrast, low service life compared to that of the illumination systems using light-emitting diodes that are at present considered as most promising.

At the same time, the use of light-emitting diodes generates a problem of providing a uniform illumination on the display surface, since the light-emitting diodes have a high luminosity that induces the formation of a high non-uniformity of the display illumination characterized by bright spots. For solving this problem, a secondary optics is used enabling to control the color diagram of the source.

It is known the invention “Lens for forming the emission of a light-emitting diode” (RU patent No 2303800C1, Int. CI. G02B27/09, published on Jul. 27, 2007) of the Korean Company Samsung, related to the design of a secondary optics for a light-emitting diode, where the authors propose to use an axis-symmetric lens with two surfaces, that enables to reduce the effect of bright spots. A drawback of this solution is the use of a two-surfaced lens that requires high engineering outlays and the need of further positioning while securing onto the light-emitting diode, compared to lenses with a single working surface.

The paper of Wang, K. New reversing design method for LED uniform illumination/Kai Wang, Dan Wu, Zong Qin, Fei Chen, Xiaobing Luo, and Sheng Liu//Opt. Exp.-2011.-Vol. 19.-P. A830-A840 describes a method for providing a uniform illumination with the help of a multitude of LEDs each one of which bears an axis-symmetric lens. The authors analyze the distribution of the illumination from the multitude of LEDs and find a curve of luminous intensity. On the basis of the curve of luminous intensity, one finds the shape of a lens, that provides for a uniform illumination. A drawback of this method is a limitation of the distance between the light-emitting diodes, since the lens operates according to the effect of refraction and cannot deflect a ray to big angles. That is why the present method, in contrast to the claimed solution, cannot provide for a lower number of light-emitting diodes per unit of illuminated area.

The closest prior art to the claimed solution is a method used by the invention “Compact optical system and lenses to form a uniform collimated light” (RU patent No 2475672C2, Int. CI. F21S8/10, F21V5/04, published on Oct. 20, 2012) of the Dutch company Philips. To obtain a uniform illumination, the rays issued from a light-emitting diode first pass through a cylindrical lens that collimates them to send to a reflector constituted by several specifically chosen surfaces. This method enables to provide for a high uniformity but in this case the lens has always two surfaces and the reflector has a complicated stepped shape. Besides, for illuminating a screen of a big size, it is necessary to use a multitude of light-emitting diodes, which increases the production costs.

### SUMMARY OF THE INVENTION

The solution of the present application enables to solve the existing problems thanks to the use of lenses of a simple shape with a single working surface, to the provision of a high uniformity, to the use of a lower amount of light-emitting diodes, to a lesser thickness of the optical system.

In this case, the optical system comprises a light-diffusing substrate (in particular a Lambertian reflector), a multitude of light-emitting diodes with cylindrical lenses (or reflectors) having the axis of symmetry in the substrate plane, several layers of optical elements (for example, diffusers). Each lens (or reflector) that is mounted onto a light-emitting diode simulates a cold-cathode tube by means of formation of a uniformly illuminated section on the substrate. The illuminated section becomes a secondary light source. As a light-diffusing substrate, use can be made of Spectralon having the reflection factor superior to 99% (Bhandari, A. Bidirectional reflectance distribution function of Spectralon white reflectance standard illuminated by incoherent unpolarized and plane-polarized light/Anak Bhandari, Borge Hamre, Ovynd Frette, Lu Zhao, Kakob J. Stamnes, and Morten Kildemo//Applied Optics, 2011, Vol. 50(16), P. 2431-2442), but in a common case, as a light-diffusing substrate, use can be made of a more complicated structure, for example, such as longitudinal notches that provide for light diffusion under high angles, at least in a single direction (i.e. it is not any more according to the Lambert's law).

### DETAILED DESCRIPTION

While the present teachings are described in conjunction with various embodiments and examples, it is not intended that the present teachings be limited to such embodiments. On the contrary, the present teachings encompass various alternatives and equivalents, as will be appreciated by those of skill in the art.

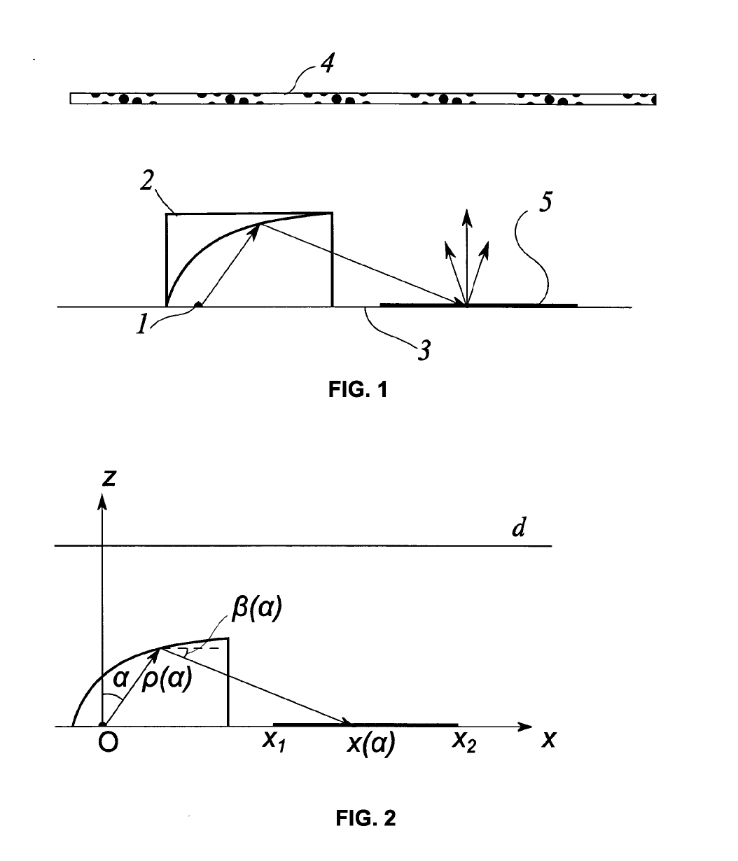

The device is described with reference to drawings where FIG. 1 illustrates a diagram of a display illumination.

A light source 1, an optical element 2 made as a lens or a reflector. A light-diffusing substrate 3 is made as a Spectralon sheet. 4 represents a set of optical elements for diffusers, polarizers, filters. 5 is a uniformly illuminated section.

### Embodiment of the Method

The optical element 2 redirects radiation from a point-source 1 (a compact one) onto a section 5 on the surface of a light-diffusing substrate 3 with the length of 200 mm. To obtain a better uniformity, use is made of a set of optical elements such as diffusers, polarizers, filters.

FIG. 2 illustrates a system of coordinates and symbols used for calculating a reflector. The optical element has an axis of rotation (axis Ox) and is calculated for operation with rays in a determined range of angles α∈ [−π/2,αₘₐₓ], where αₘₐₓ is in the limits of 45° to 70°. The choice of an angle determines the dimensions of a reflector and the quantity of luminous energy used to form sections (for example, for a Lambertian source, more than 90% of luminous energy gets in the range of angles of −60° to 60°). We have neglected the rays that are not reflected by the reflector surface but come directly onto the screen.

In the present example for the angle range [−90°; 70°], the following values of dimensions were obtained: the length obtained along the axis Ox was about 20 mm, the width was 12 mm and the height was 6 mm.

FIG. 2 comprises the symbols as follows: p(α), the length of the radius vector for the profile point, where α∈ [−π/2,αₘₐₓ] is the angle coordinate of an incident ray. The publication (Moiseev M. A. Calculation of radially symmetric refractive surfaces with regard to Fresnel losses/L. L. Doskolovich, M. A. Moiseev//Computer optics, 2008, V. 32, No 1. P. 201-203.) shows for p(α) the following differential equation:

$$\frac{d ρ ( α )}{d α} = ρ ( α ) \cdot cot ( \frac{π / 2 - α - β ( α )}{2} ) , \qquad ( 1 )$$

where the function β(α) assigns the ray direction after reflection. The geometry in FIG. 2 gives the coordinate of intersection of the ray issuing from the optical element with the axis Ox equal to:

$$x ( α ) = ρ ( α ) sin ( α ) + \frac{ρ ( α ) cos ( α )}{tg ( β ( α ) )} . \qquad ( 2 )$$

Then the function β(α) takes the following form:

$$β ( α ) = arctg \frac{ρ ( α ) cos ( α )}{x ( α ) - ρ ( α ) sin ( α )} . \qquad ( 3 )$$

Now let's determine the function x(α) in the right part of (3) on the basis of the law of conservation of the luminous flux. Let's input the spherical coordinates (α,φ), where φ is a polar angle in the plane YOZ perpendicular to the plane of FIG. 2. Since the optical element is disposed at z>0, then φ∈ [0, π]. In the indicated coordinates, a solid angle element corresponding to the section φ∈ [0, π] has the form:

dΩ(α)=π sin(π/2−α)dα.

For writing the law of conservation of the luminous flux, it is necessary to put the luminous flux incident of the element dx of the illuminated section equal to the luminous flux from a source, emitted onto the solid angle element dΩ (α). Thus, one can write the equality as follows:

$$sin ( π / 2 - α ) ( {\int }_{0}^{π} I ( α , ϕ ) d ϕ ) d α = E ( x ) d x , \qquad ( 4 )$$

where E(x), x∈ [x₁, x₂] represent the given illumination at the section (x₁, x₂ are coordinates of the beginning and the end of the section), I(α,φ) is the source intensity. We note that a correct assignment of the illumination E(x) requires the implementation of the valuation conditions:

$${\int }_{0}^{{α}_{max}} sin ( π / 2 - α ) [ {\int }_{0}^{π} I ( α , ϕ ) d ϕ ] d α = {\int }_{{x}_{1}}^{{x}_{2}} E ( x ) d x . \qquad ( 5 )$$

At a constant illumination E(x)=E₀, x∈ [x₁, x₂], we integrate (5) and obtain the following:

$$x ( α ) = {x}_{1} + \frac{1}{{E}_{0}} {\int }_{0}^{α} cos α [ {\int }_{0}^{π} I ( α , ϕ ) d ϕ ] d α . \qquad ( 6 )$$

In the case of a Lambertian source radiating along the axis Oz, the source intensity in the coordinates (a,φ) has the form:

I(α, φ)=I₀cos αsin φ. (7)

Substituting (7) in (6), we obtain x (α) in an analytical form:

$$x ( α ) = {x}_{1} + \frac{{x}_{2} - {x}_{1}}{{α}_{max} + \frac{sin 2 {{α}_{max}}_{ }}{2}} ( α + \frac{sin 2 α}{2} ) . \qquad ( 8 )$$

Substitute the function x(α) in (3) and obtain the equation as follows:

$$β ( α ) = arctg \frac{ρ ( α ) cos ( α )}{{x}_{1} + \frac{{x}_{2} - {x}_{1}}{{α}_{max} + \frac{sin 2 {α}_{max}}{2}} ( α + \frac{sin 2 α}{2} ) - ρ ( α ) sin ( α )} . , \qquad ( 9 )$$

Thus, the calculation of an optical element for forming a section with a given illumination is reduced to the integration of the differential equation (1).

Within the framework of the considered approach, it is assumed that the optical element forms an illuminated section on the illuminated substrate. Let's consider that a Lambertian surface is used as a substrate (http://www.labsphere.com/products/reflectance-materials-and-coatings/high-reflectance-materials/default.aspx.). In this case, the section illuminated will represent a secondary Lambertian source.

The developed method for calculating an optical element is implemented in the program medium Matlab (http://www.mathworks.com/).

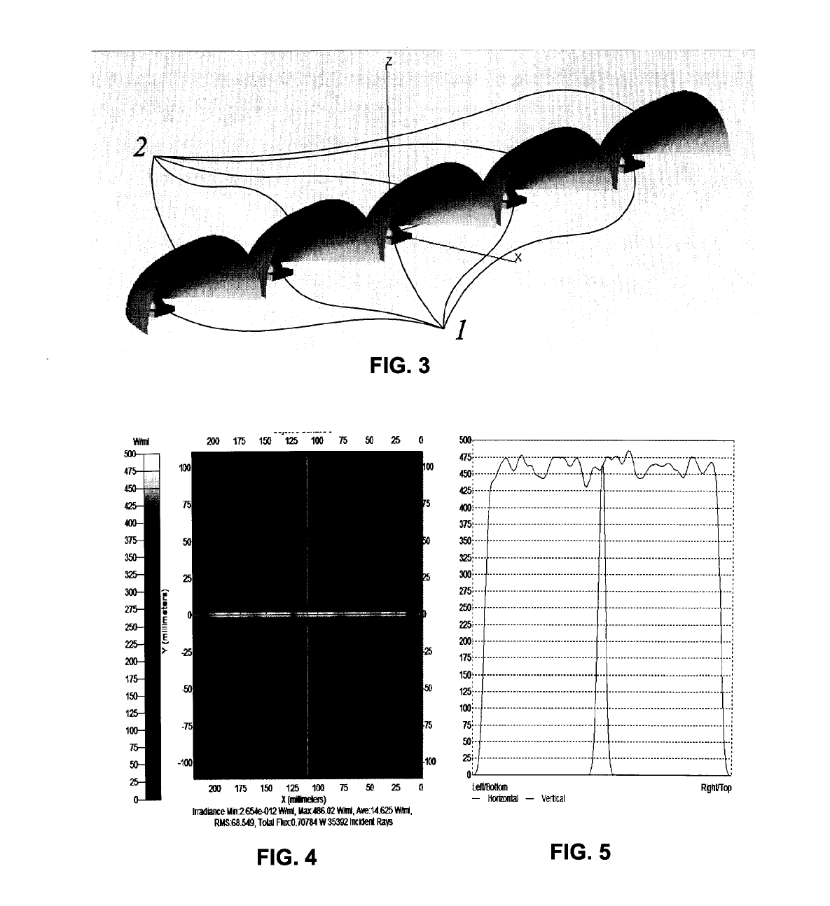

FIG. 3 represents a three-dimensional model of a set of 5 sources with reflectors, spaced from each other to a distance of 20 mm, each one of them providing for a reliable illumination of a section with the length of 200 mm (while x₁=0).

The distance from the source to the lens surface along the axis Oz is chosen equal to 1 mm, and the maximum working angle αₘₐₓ=70°.

To check the correctness of the calculations, a modeling of the work of the calculated optical system with the program for lighting engineering computations TracePro with the use of the method for tracing rays was carried out (http://www.lambdares.com/software products/tracepro/).

FIG. 4 illustrates the lighting distribution calculated for 1000000 rays and formed in the plane z=0 containing the section.

FIG. 5 illustrates the distributions along the axes Ox and Oy.

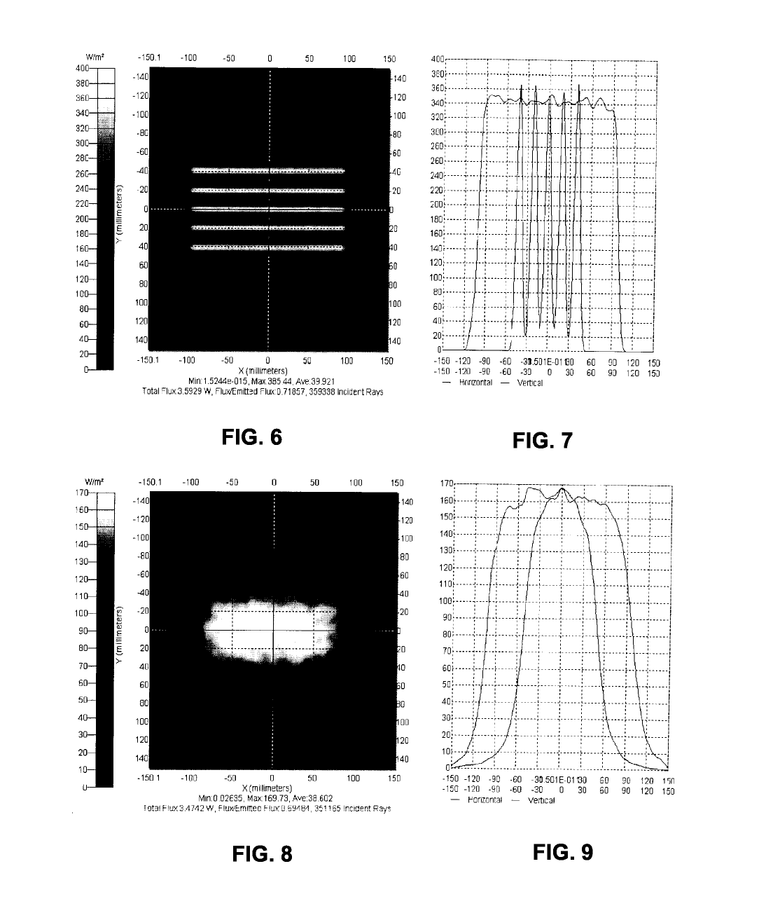

FIG. 6 illustrates the distribution of lighting formed by a set of 5 optical elements located on the right at a distance of 100 mm from the origin of coordinates. FIG. 7 illustrates the distributions along the axes Ox and Oy.

When using an optical element or a set of optical elements forming sections, a light-diffusing substrate is located in the plane z=0. In this case, the final task is to obtain a uniform light distribution in a plane z=d (FIG. 2) above the optical element, on a display.

FIG. 8 Illustrates the illumination distribution for 5 sources with reflectors, spaced at 20 mm from the display plane (z=d).

FIG. 9 illustrates the distributions along the axes Ox and Oy. Note that the plane z=0 of the present example corresponds to a Lambertian reflector. The standard deviation of the illumination in the plane d is less than 6% in the central area with the dimensions 300 mm×400 mm. The energy efficiency (the part of a radiated luminous flux arriving at the detector) is higher than 90%.

The technical result of the use of the present invention consists in improving the light characteristics of displays such as efficiency, lighting homogeneity, and reducing the cost of the system thanks to the use of lenses (reflectors) with one working surface and a smaller number of highly effective light sources (light-emitting diodes).

All references disclosed herein are incorporated by reference.

The foregoing description of one or more embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

1. A method for providing a uniform lighting in a system of illuminating a display, comprising redirecting radiation from sources with the aid of lenses or reflectors, wherein the radiation is redirected onto a light-diffusing substrate and uniformly illuminated sections are produced which in turn form a uniform illumination of the display.

2. The method of claim 1, wherein the light-diffusing substrate reflects the incident light according to Lambert's law.

3. The method of claim 1, wherein a length of each uniformly illuminated section is in the range of 50 mm to 200 mm.

4. The method of claim 1, wherein a distance from the sources to the display plane is in a range of 20 mm to 50 mm, and dimensions of the illuminated area are greater than 200 mm×200 mm.

5. A device for illuminating a display, comprising light-emitting diodes, lenses or reflectors, and a deflector, wherein each lens or reflectors has one working surface representing a surface of revolution with an axis of symmetry coincident with a straight line along which a uniformly illuminated section is formed, the deflector comprises a light-diffusing substrate comprised of a light-diffusing material.

6. The device of claim 5, wherein the light-diffusing substrate comprises a Spectralon sheet.

7. The device of claim 5, wherein the light-diffusing substrate includes longitudinal notches.

8. The device of claim 5, further comprising a set of optical elements selected from the group consisting of diffusers, polarizers, and filters.
